(19) United States
(12) Patent Application Publication
(10) Pub. No.: US 2022/0402179 A1
(43) Pub. Date: Dec. 22, 2022

(54) INJECTION MOULDING PROCESS APPLIED TO METAL SHELL, THE METAL SHELL, AND MANUFACTURING PROCESS METHOD OF THE METAL SHELL

(71) Applicants: FUYU PRECISION COMPONENT(KUNSHAN)CO.,LTD., Suzhou (CN); Foxconn Technology Co., Ltd., New Taipei (TW)

(72) Inventors: CHING-SHENG SUN, New Taipei (TW); FUH-FENG TANG, New Taipei (TW); HUNG-CHUN MA, New Taipei (TW); MING-HUI LIN, New Taipei (TW); SI-HUI REN, Kunshan (CN)

(21) Appl. No.: 17/740,957

(22) Filed: May 10, 2022

(30) Foreign Application Priority Data
Jun. 18, 2021 (CN) 202110677330.4

(51) Int. Cl. B29C 45/14

(52) U.S. Cl. CPC B29C 45/14311; B29C 2045/14327; B29K 2905/02; B29K 2067/006

(57) ABSTRACT

An injection molding process method of a plastic part on a metal shell to form a high-strength combination comprises: forming a molding cavity which is inwardly concave from the outer surface and extending through flanges at periphery of the metal shell to area beneath bridges protruding from flanges, the bridges being removed after the injection molding. A plastic part with slight deformation is in the molding cavity and is tightly combined with the metal shell due to the bridges. The protruding bridges can be removed from the flanges by milling or cutting without damaging the plastic part, thus the plastic part does not require to be remachined, and the appearance of the metal shell is not affected.

### CROSS-REFERENCE TO RELATED APPLICATIONS

This application claims priority to China Application No. 202110677330.4, having a filing date of Jun. 18, 2021, filed in China State Intellectual Property Administration, the entire contents of which is hereby incorporate by reference.

### FIELD

The subject matter relates to metal shell manufacturing, and more particularly, to an injection molding process method applied to a metal shell, the metal shell, and a manufacturing process method of the metal shell.

### BACKGROUND

Today's market is looking for thinner, lighter, more durable notebooks with more elegant appearance, which presents a challenge for manufacturers of notebook shells. Notebook shells are mostly formed of metal. However, the notebooks with metal shells would have a weak signal strength as the metal material creates electromagnetic shielding of antennae in the notebooks. Therefore, the metal shell requires to be modified to reduce the electromagnetic shielding of the antennae, for example, the metal shell is formed with through holes at positions corresponding to the antennae, the through holes being filled with plastic materials to avoid electromagnetic shielding effect.

However, in practice, cracking or uneven surfaces and other defects often occur, as the plastic materials do not tightly combine with the metal shell due to deformation during the injection molding process.

### SUMMARY

An objective of the present disclosure is achieved by providing an injection molding process method applied to a metal shell,

wherein the metal shell comprises an outer surface and an inner surface, the metal shell is arranged with flanges on periphery and two bridges protruding from the flanges on different sides of the metal shell,

the injection molding process method comprises:

step S12: forming a molding cavity, the molding cavity being inwardly concave from the outer surface and extends to beneath the bridges;

step S14: injection molding, a plastic part being formed in the molding cavity by injection molding;

step S16: removing the bridges.

According to a further aspect of the disclosure, the molding cavity comprises a first groove, two second grooves on either side of the first groove, two first through holes respectively located between the first groove and each of the second grooves, and two second through holes respectively located between each of the second grooves and each of the bridges.

According to a further aspect of the disclosure, a first connection is formed between the inner surface and a bottom of the first groove, two second connections are formed between the inner surface and bottoms of each of the two second grooves, respectively;

side faces of each of the first and second connections adjacent to the through holes are configured as curved surfaces.

According to a further aspect of the disclosure, each of the second through holes is provided with a reinforcer, the distance between an edge of the reinforcer close to the outer surface and another edge of the reinforcer close to the inner surface is smaller than the distance between the outer surface and the inner surface.

According to a further aspect of the disclosure, the plastic part formed in the molding cavity comprises a first plastic part received in the molding cavity and two second plastic parts protruding from the inner surface, the first plastic part is connected to the two second plastic parts, and the two second plastic parts are separated by the first connection;

a vertical projection of each second plastic part on the outer surface is wider than that of the first plastic part on the outer surface;

a vertical projection of each second plastic part on the outer surface partially overlaps with the vertical projection of the first groove on the outer surface.

According to a further aspect of the disclosure, a vertical projection of the bridges on the outer surface is wider than that of the molding cavity on the outer surface.

According to a further aspect of the disclosure, a manufacturing process method of a metal shell comprises:

Step S22: forming a metal body;

Step S24: machining the metal body, the metal body being machined to form a metal shell with flanges and two bridges protruding from the flanges;

Step S26: implementing the injection molding process on the metal shell mentioned above;

Step S28: performing a fine machining on the metal shell.

According to a further aspect of the disclosure, a metal shell is provided for a plastic part to be molded thereon, wherein,

the metal shell is formed with a molding cavity at a predetermined position and with flanges at periphery, the molding cavity extends through the flanges at two ends, the flanges on opposite edges of the metal shell are arranged with two bridges protruding therefrom, the bridges span the molding cavity and can be removed after the injection molding.

According to a further aspect of the disclosure, the molding cavity comprises a first groove, two second grooves on either side of the first groove, two first through holes respectively located between the first groove and each of the second grooves, and two second through holes respectively located between each of the second grooves and each of the bridges.

According to a further aspect of the disclosure, the plastic part formed in the molding cavity comprises a first plastic part received in the molding cavity and two second plastic parts protruding from the inner surface, the first plastic part is connected to the two second plastic parts, the two second plastic parts are separated by the first connection;

a vertical projection of each second plastic part on the outer surface is wider than that of the first plastic part on the outer surface;

a vertical projection of each second plastic part on the outer surface partially overlaps with the vertical projection of the first groove on the outer surface.

A small deformation exists in the plastic part as being tightly combined with the metal shell due to the bridges arranged on the flanges and roughened surface of the metal shell. The plastic part does not affect the signal transmittance of the antennae as almost no metal material is present in the plastic part; the bridges protruding from the flanges can be removed by milling, cutting, or other process without damaging the plastic part, therefore the plastic part does not require to be remachined for restoring, and the appearance of the metal shell is not affected.

### BRIEF DESCRIPTION OF THE DRAWINGS

Implementations of the present technology will now be described, by way of example only, with reference to the attached figures.

FIG. 1 is a flow diagram of an injection molding process method on a metal shell of an embodiment according to the present disclosure;

FIG. 2 is a perspective view of the metal shell before the injection molding process method according to an embodiment of the present disclosure;

FIG. 3 is another perspective view of the metal shell before the injection molding process method according to an embodiment of the present disclosure;

FIG. 4 is a perspective view of the metal shell after the injection molding process method according to an embodiment of the present disclosure;

FIG. 5 is another perspective view of the metal shell after the injection molding process method according to an embodiment of the present disclosure;

FIG. 6 is a perspective view of plastic part shown in FIG. 4 according to an embodiment of the present disclosure.

FIG. 7 is a perspective view of the metal shell with bridges removed according to an embodiment of the present disclosure.

FIG. 8 is a flow diagram of a manufacturing process method of the metal shell of an embodiment according to the present disclosure.

### DETAILED DESCRIPTION

It will be appreciated that for simplicity and clarity of illustration, where appropriate, reference numerals have been repeated among the different figures to indicate corresponding or analogous components. The description is not to be considered as limiting the scope of the embodiments described herein. The drawings are not necessarily to scale and the proportions of certain parts may be exaggerated to better illustrate details and features of the present disclosure.

It should be understood that, the terms “first” and “second” are used to distinguish elements and are not used to denote a particular order or imply a number of technical features, therefore, unless being specifically defined, features described with “first” and “second” may expressly or implicitly include one or more of the stated features. In the description of the present application, “plurality” means two or more, unless otherwise expressly and specifically defined.

In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described.

The term “comprising,” when utilized, means “including, but not necessarily limited to”; it specifically indicates open-ended inclusion or membership in the so-described combination, group, series, and the like.

A detailed description of the hereinafter described embodiments of the disclosure is presented herein by way of exemplification and not limitation with reference to the figures.

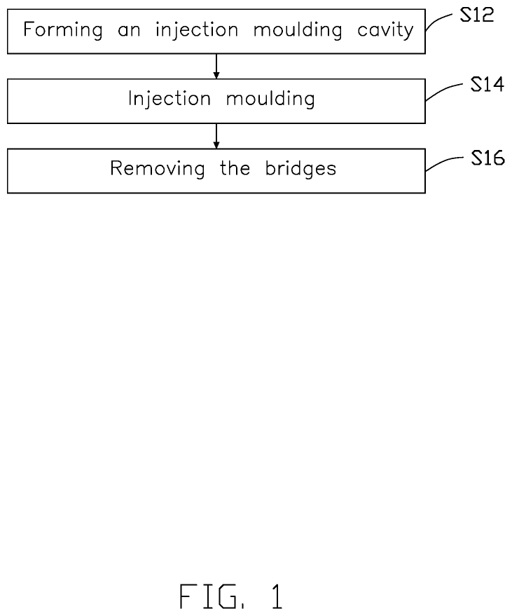

Referring to FIG. 1, a flow diagram of a method for an injection molding process method applied to a metal shell is provided by a first embodiment according to the present disclosure. The process method reduces deformation of plastic materials during the injection molding process method and improves combining capacity between the plastic and the metal shell.

The plastic material is a mixture of Polybutylene Terephthalate (PBT) and Glass Fiber (GF), in this embodiment, the plastic materials are a mixture of 60% PBT and 40% GF.

It should be understood that, PBT and GF can be mixed in other ratio. The plastic materials can be one of Polyphenylene Sulfide (PPS) and Polyamide (PA) or a mixture thereof.

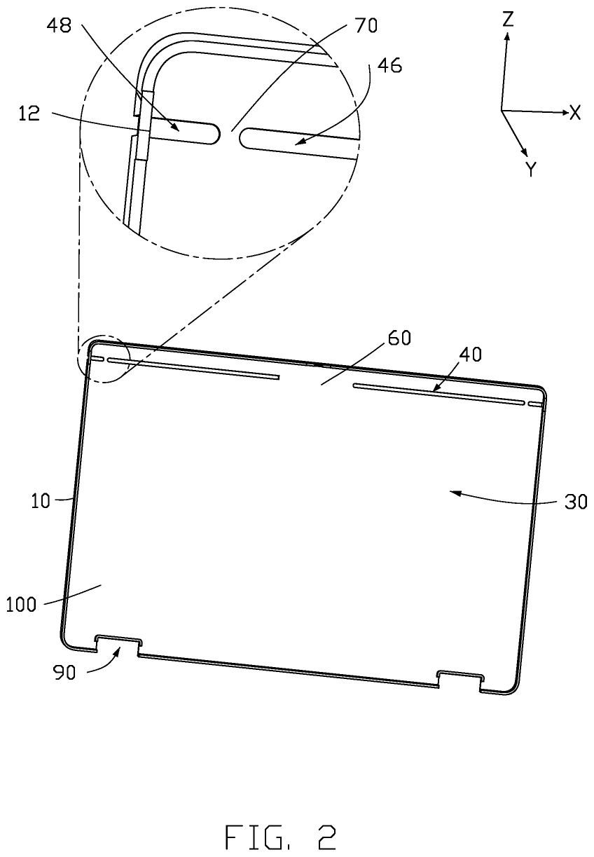

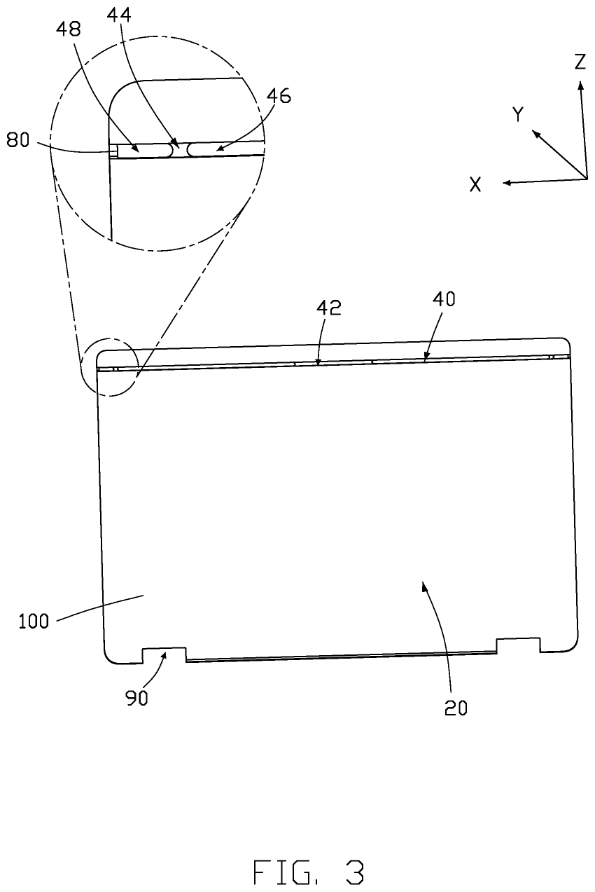

Referring to FIGS. 2-3, the metal shell 100 comprises an outer surface 20 and an inner surface 30, the metal shell 100 is arranged with flanges 10 on periphery and two bridges 12 protruding from the flanges 10 on different sides of the metal shell 100.

In this embodiment, the metal shell 100 is substantially rectangular, the two bridges 12 are arranged on opposite flanges on the left and right edges of the rectangle. The distances between an upper edge of the rectangle and the two bridges 12 are equal but smaller than that between a lower side of the rectangle and the two bridges 12.

For the purpose of illustration, the term “length direction”, “extension direction of the upper/lower edge of the metal shell 100” are defined as X-axis direction as shown in FIG. 2, and the term “width direction”, “extension direction of the left/right edge of the metal shell 100” are defined as the Z-axis direction as shown in FIG. 2. The term “side edges” mean the upper edge, the lower edge, the left edge, or the right edge.

It should be understood that, in further embodiments, the bridges 12 are arranged on flanges on adjacent edges of the rectangle, or the two bridges 12 are arranged on opposite flanges but with unequal distances from the bridges 12 to the side edge therebetween. In this application, the positions of the two bridges 12 are regulated according to the position of the antennae of the metal shell 100, the flanges are interrupted at the bridges 12 and are connected by the bridges 12.

Referring to FIG. 1, some steps in FIG. 1 can be omitted according to different requirements. For simplicity of illustration, only steps related to the present embodiment are shown. The injection molding process method applied to the metal shell 100 comprises following steps:

S12: forming a molding cavity 40, the molding cavity 40 is an inward concavity from the outer surface 20 and extends to beneath the bridges 12.

More specifically, the molding cavity 40 is formed by milling the outer surface 20. The molding cavity 40 can be formed on the outer surface 20 by machining or any other appropriate method.

In this embodiment, the metal shell 100 is made of aluminum alloy, magnesium-aluminum alloy, or other metal suitable for shells of notebook computers, provided that the plastic material should be arranged on the metal shell 100 at positions corresponding to the antennae of the notebook computer, to reduce electromagnetic shielding of the antennae by the metal shell 100.

The bridges 12 are rectangular, round, oval, or other shape. In direction of Y-axis in FIG. 2, the width of vertical projection of the bridges 12 on the outer surface 20 is larger than that of the molding cavity 40 on the outer surface 20. Therefore, the bridges 12 help to retain the plastic materials injected in the molding cavity 40. The term “width” refers to a width in direction of Z-axis in FIG. 2.

According to a further embodiment, as shown in FIGS. 2-3, in direction of X-axis, the molding cavity 40 comprises a first groove 42, two second grooves 44 on either side of the first groove 42, two first through holes 46 respectively located between the first groove 42 and the second grooves 44, and two second through holes 48 respectively located between the second grooves 44 and the bridges 12. The second through holes 48 extend from the molding cavity 40 to the bridges 12. That is, in direction of X-axis, the molding cavity 40 comprises one second through hole 48, one second groove 44, one first through hole 46, the first groove 42, the other one of the first through holes 46, the other one of the second grooves 44, and the other one of the second through holes 48.

It should be understood that more or fewer grooves or through holes can be arranged for the molding cavity 40. However, the molding cavity 40 comprises at least one groove and at least one through hole, wherein the groove is used for improving the strength of the metal shell 100 and the through hole is used for enhancing the strength of the combination between the plastic materials and the metal shell 100.

A first connection 60 is formed between the inner surface 30 and the bottom of the first groove 42, and two second connections 70 are formed between the inner surface 30 and the bottom of the two second grooves 44, respectively, therefore the structural influence of the molding cavity 40 on the strength of the metal shell 100 is less, deformation of the metal shell 100 during injection molding is avoided, and plastic materials are tightly combined with the metal shell 100.

According to a further embodiment, the first connection 60 is located approximately in the middle of the molding cavity 40, top surface of the first connection 60 belongs to the same plane with the bottom of the first groove 42, and bottom surface of the first connection 60 belongs on the same plane as the inner surface 30. The top surface of the second connection 70 belongs on the same plane as the bottom of second groove 44, but bottom surface of the second connection 70 is not on the same plane as the inner surface 30. Thus, at least two second connections 70 are embedded in the plastic materials and the structural strength of the metal shell 100 is improved.

The side faces of the first and second connections 60, 70 adjacent to the through holes are curved surfaces. Preferably, the curved surfaces are in an arc shape. Therefore, the combination between the plastic materials and the metal shell 100 is further improved.

It should be understood that, the curved surfaces can be configured as a corrugated surface or other form.

In this embodiment, each of the second through holes 48 is provided with a reinforcer 80. The thickness of the reinforcer 80 is less than that of the second through hole 48, that is, in direction of Y axis, the distance between an edge of the reinforcer 80 close to the outer surface 20 and other edge of the reinforcer 80 close to the inner surface 30 is less than the distance between the outer surface 20 and the inner surface 30. The reinforcers 80 are embedded in the plastic materials to improve the structural strength of the metal shell 100 and provide connections between the metal shell 100 and external components.

According to a further embodiment, the reinforcer 80 is formed as a sheet with the ends connected to the metal shell 100 at the inner surface of the molding cavity 40.

In further embodiments, the reinforcer 80 is formed in other shape, such as rod-shaped.

In further embodiments, the step S12 can be omitted, that is, the molding cavity 40 can be formed during processing of the metal shell 100.

Step S14: injection molding, a plastic part being formed in the molding cavity 40 by injection molding.

In particular, an injection mound (not shown) is placed at the molding cavity 40, then plastic material is injected to form the plastic part in the molding cavity 40, then the injection mound is removed.

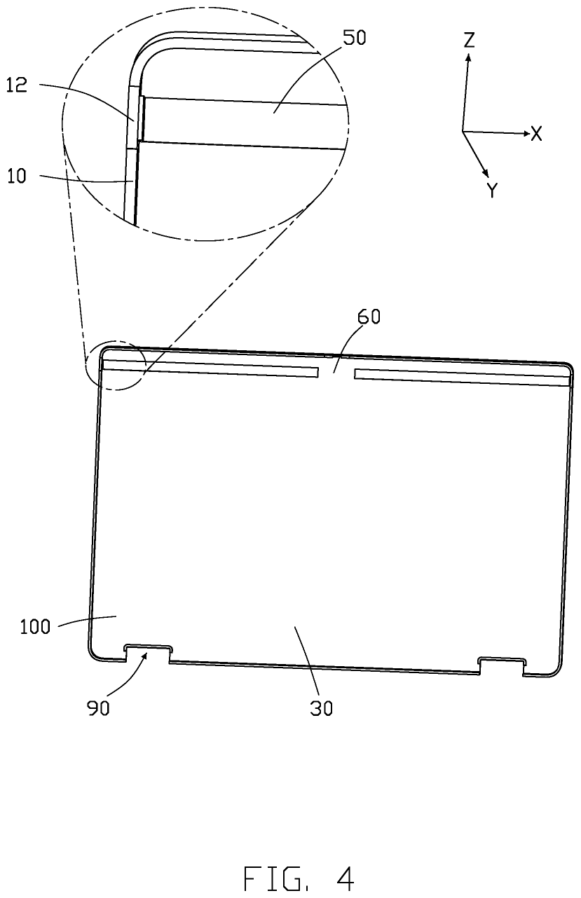

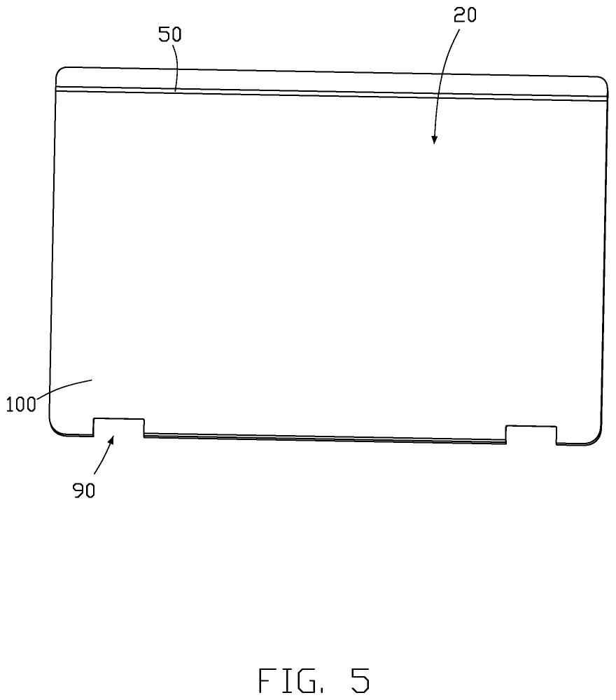

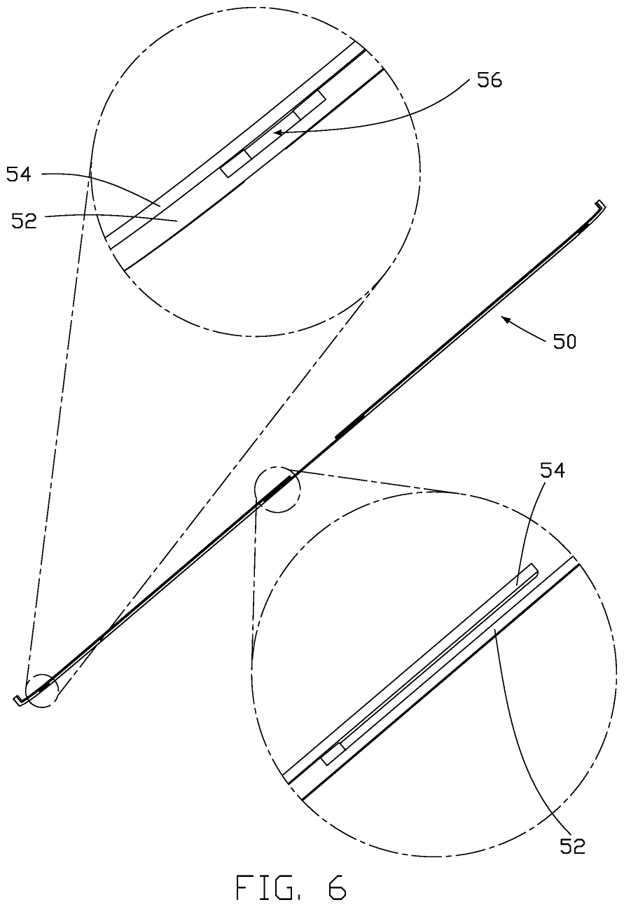

Referring to FIGS. 4-6, the plastic part 50 formed in the molding cavity 40 comprises a first plastic part 52 received in the molding cavity 40 and two second plastic parts 54 protruding from the inner surface 30, the two second plastic parts 54 are separated by the first connection 60.

In the Z axis direction, the first plastic part 52 formed in the molding cavity 40 has a same width as the molding cavity 40, which is less than that of the second plastic part 54.

The vertical projection of the second plastic part 54 on the outer surface 20 partially overlaps with the vertical projection of the first groove 42 on the outer surface 20, that is, each second plastic part 54 overlaps with the first groove 42 at the end away from the bridge 12.

Therefore, the first connection 60, the second connections 70, and the reinforcers 80 are surrounded by the plastic part 50, which improves degree of combination of the plastic part 50 and the metal shell 100.

The first plastic part 52 is formed with two holes 56 by the second connections 70, so the second connections 70 are embedded in the first plastic part 52; the reinforcers 80 in the second through holes 48 are also embedded in the first plastic part 52.

In this embodiment, before the process of injection molding, surfaces of the first connection 60, the second connection 70, and the molding cavity 40 are treated by a T treatment for roughening, which further improves the combination of the metal shell 100 and the plastic part 50.

In particular, the T treatment comprises following steps:

Degreasing treatment: the metal shell 100 is degreased at the first connection 60, the second connection 70, and the molding cavity 40;

Washing: washing the metal shell 100 after the degreasing treatment;

Pickling: the metal shell 100 is etched by acid at the first connection 60, the second connection 70, and the molding cavity 40;

T solution etching: the metal shell 100 is etched by T solution at the first connection 60, the second connection 70, and the molding cavity 40 to form nano-sized pits on the surface. After the T treatment, nano-sized pits of 20 nm-40 nm and grain projections of 50 nm-80 nm exist on the surface of the metal shell 100, improving the bonding between the metal shell 100 and the plastic part 50.

Step S16: removing the bridges 12.

In particular, the bridges 12 can be removed by milling, cutting, or other process without damaging the plastic part 50, as the bridges 12 protrude from the flanges 10.

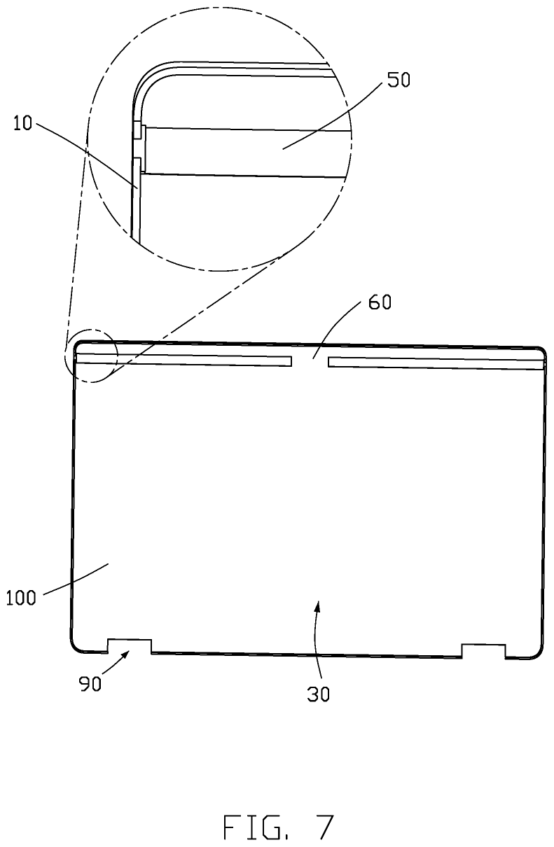

Referring to FIG. 7, the plastic part 50 is exposed after removing the bridges 12.

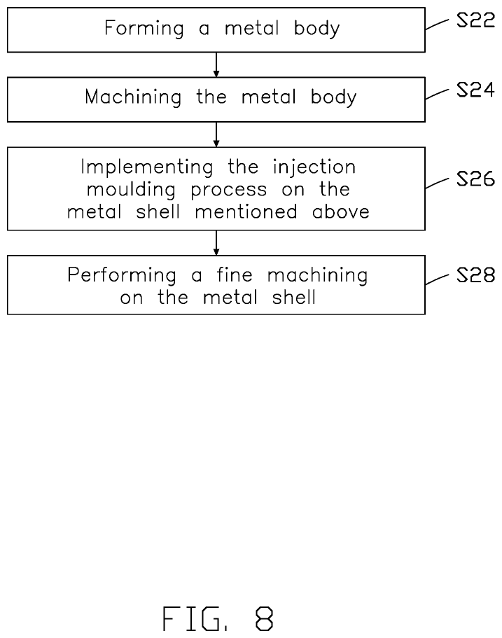

Referring to FIG. 8, according to a further embodiment, a flow diagram of a method of manufacture of a metal shell is provided, some steps in the flow diagram can be omitted or performed in different order. For simplicity of illustration, only steps related to the present embodiment are shown. The manufacturing process of the metal shell 100 comprises following steps:

Step S22: forming a metal body (not shown).

In particular, the metal body is formed by stamping, squeezing, and molding a piece of metal with good malleability, then the metal body cooled and processed by depressing for following procedures.

Step S24: machining the metal body, the metal body being machined to form a metal shell 100 with flanges 10 and two bridges 12 protruding from the flanges 10.

In particular, the metal body is machined by a Computerized Numerical Control (CNC) lathe to form hinge portion 90 at one edge of the metal body and flanges 10 on periphery of the metal body, wherein the bridges 12 are arranged on and protrude from flanges 10 of two opposite edges. In further embodiments, the metal body is processed by a milling machine for satisfying requirements of size, surface, and quality. In further embodiments, the metal body is processed by a drilling machine to form hole such as threaded holes for mounting.

Step S26: implementing the injection molding process on the metal shell 100.

In particular, the plastic part 50 is formed on the metal shell 100 by the injection molding process, wherein the position of the plastic part 50 is corresponding to the antennae on the notebook computer for avoiding influence of the metal shell 100 on signal transmittance of the antennae.

Step S28: performing a fine machining on the metal shell 100.

In particular, defections like rough edges and burrs are generated on the metal shell 100 after the processes of CNC, milling, and drilling, the metal shell 100 requires grinding treatment after the injection molding for removing the defections and improving the surface quality.

The fine machining process on the metal shell 100 further comprises at least one of: chamfering, polishing, brush finishing, sand blasting, and anodizing, for example, after injection molding, the metal shell 100 is processed by polishing, brush finishing, chamfering, sand blasting, and anodizing in sequence.

It should be understood that, the metal shell 100 can be processed by other fine machining processes.

A mall deformation exist in the plastic part as being tightly combined with the metal shell 100 due to the bridges 12 arranged on the flanges 10 and roughened surface of the metal shell 100. The plastic part 50 does not affect the signal transmittance of the antennae as almost no metal material is present in the plastic part; the bridges 12 protruding from the flanges 10 can be removed by milling, cutting or other process without damaging the plastic part 50, therefore the plastic part 50 does not require to be remachined for restoring, and the appearance of the metal shell 100 is not affected.

A metal shell is provided by a further embodiment, which is used for the plastic part 50 to be molded thereon. Referring to FIGS. 2 and 7, FIG. 2 shows a semifinished product of the metal shell 100 for injection molding, FIG. 7 shows a final product of the metal shell 100 after injection molding. The metal shell 100 is formed with a molding cavity 40 at a predetermined position and flanges 10 at peripheral, the molding cavity 40 extend through the flanges 12 at two ends, the flanges 12 on two opposite edges of the metal shell 100 are arranged with two bridges 12 protrude therefrom, wherein the bridges 12 span the molding cavity 40 and can be removed after the injection molding.

In this embodiment, the term “predetermined position” refers to positions corresponding to the antennae of the notebook computer.

It should be understood that the term “predetermined position” refers to positions corresponding to other electronic components of the notebook computer in further embodiments.

According to a further embodiment, the molding cavity 40 comprises a first groove 42 and two second grooves 44 on either side of the first groove 42, two first through holes 46 respectively located between the first groove 42 and the second grooves 44, and two second through holes 48 respectively located between the second grooves 44 and the bridges 12.

Corresponding to the molding cavity 40, the plastic part 50 formed in the molding cavity 40 comprises a first plastic part 52 received in the molding cavity 40 and two second plastic parts 54 protruding from the inner surface 30, the first plastic part 52 is connected to the two second plastic parts 54, the two second plastic parts 54 are separated by the first connection 60. The first plastic part 52 formed in the molding cavity 40 has a width less than that of the second plastic part 54, the vertical projection of the second plastic part 54 on the outer surface 20 partially overlaps with the vertical projection of the first groove 42 on the outer surface 20.

The metal shell 100 is provided with bridges 12 protrude from the flanges on the metal shell 100 for retaining the injected plastic in the molding cavity 40, therefore the plastic part is provided with a small deformation as being tightly combined with the metal shell 100 due to the bridges 12. The bridges 12 protruding from the flanges 10 can be removed by milling, cutting or other processes without damaging the plastic part 50, therefore the plastic part 50 does not require to be remachined for restoring, and the appearance of the metal shell is not affected.

While the invention has been described in detail in connection with only a limited number of embodiments, it should be readily understood for the skilled in the art that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An injection molding process method applicable to a metal shell,
wherein the metal shell comprises an outer surface and an inner surface, the metal shell is arranged with flanges on periphery and two bridges protruding from the flanges on different side of the metal shell,
the injection molding process method comprises:
step S12: forming a molding cavity, the molding cavity being inwardly concave from the outer surface and extends to beneath the bridges;
step S14: injection molding, a plastic part being formed in the molding cavity by injection molding;
step S16: removing the bridges.

2. The injection molding process method of claim 1, wherein
the molding cavity comprises a first groove, two second grooves on either side of the first groove, two first through holes respectively located between the first groove and each of the second grooves, and two second through holes respectively located between each of the second grooves and each of the bridges.

3. The injection molding process method of claim 2, wherein
a first connection is formed between the inner surface and a bottom of the first groove, two second connections are formed between the inner surface and bottoms of each of the two second grooves, respectively;
side faces of each of the first and second connections adjacent to the through holes are configured as curved surfaces.

4. The injection molding process method of claim 3, wherein
each of the second through holes is provided with a reinforcer, the distance between an edge of the reinforcer close to the outer surface and another edge of the reinforcer close to the inner surface is smaller than the distance between the outer surface and the inner surface.

5. The injection molding process method of claim 4, wherein
the plastic part formed in the molding cavity comprises a first plastic part received in the molding cavity and two second plastic parts protruding from the inner surface, the first plastic part is connected to the two second plastic parts, and the two second plastic parts are separated by the first connection;
a vertical projection of each of the second plastic part on the outer surface is wider than that of the first plastic part on the outer surface;
a vertical projection of each of the second plastic part on the outer surface partially overlaps with the vertical projection of the first groove on the outer surface.

6. The injection molding process method of claim 1, wherein
a vertical projection of the bridges on the outer surface is wider than that of the molding cavity on the outer surface

7. A manufacturing process method of a metal shell, comprises:
Step S22: forming a metal body;
Step S24: machining the metal body, the metal body being machined to form a metal shell with flanges and two bridges protruding from the flanges;
Step S26: implementing the injection molding process method of claim 1;
Step S28: performing a fine machining on the metal shell.

8. A metal shell, which is provided for a plastic part to be molded thereon, wherein
the metal shell is formed with a molding cavity at a predetermined position and with flanges at periphery, the molding cavity extends through the flanges at two ends, the flanges on opposite edges of the metal shell are arranged with two bridges protruding therefrom, the bridges span the molding cavity and can be removed after the injection molding.

9. The metal shell of claim 8, wherein
the molding cavity comprises a first groove, two second grooves on either side of the first groove, two first through holes respectively located between the first groove and each of the second grooves, and two second through holes respectively located between each of the second grooves and each of the bridges.

10. The metal shell of claim 9, wherein
the plastic part formed in the molding cavity comprises a first plastic part received in the molding cavity and two second plastic parts protruding from the inner surface, the first plastic part is connected to the two second plastic parts, the two second plastic parts are separated by the first connection;
a vertical projection of each of the second plastic part on the outer surface is wider than that of the first plastic part on the outer surface;
a vertical projection of each of the second plastic part on the outer surface partially overlaps with the vertical projection of the first groove on the outer surface.
